(19) United States
(12) Patent Application Publication
(10) Pub. No.: US 2004/0076732 A1
(43) Pub. Date: Apr. 22, 2004

(54) Food grade wax and process for preparing same

(75) Inventor: Marjorie Gan Valix, New South Wales (AU)

Correspondence Address: Gary M. Nath, NATH & ASSOCIATES PLLC, 6th Floor, 1030 15th Street, N.W., Washington, DC, 20005, US

(73) Assignees: JAMES COOK UNIVERSITY, Queensland (AU); CSR LIMITED, Queensland (AU)

(21) Appl. No.: 10/682,513

(22) Filed: Oct. 10, 2003

Related U.S. Application Data
(63) Continuation of application No. 09/402,362, filed on Oct. 4, 1999.
Application No. 09/402,362 is a 371 of international application No. PCT/AU98/00234, filed on Apr. 7, 1998.

(30) Foreign Application Priority Data
Apr. 7, 1997 (AU) PO 6050

(51) Int. Cl. A23D 7/00

(52) U.S. Cl. 426/601

(57) ABSTRACT

The invention provides a wax composition which can be used in comestibles. The wax composition is obtained from sugar cane and comrpises wax esters, aldehydes, tri-glycerides, alcohols, free fatty acids, sterols and polar lipids. A process for preparing a wax composition from crude sugar cane wax, the process comprising the steps of: (i) heating a solution of the crude wax with a lower alcohol as sovlent at the boiling point of the solvent; (ii) allowing phase separation of the solution from (i) and decanting the upper phase while hot; (iii) allowing the separated phase from (ii) to cool and separating crystallised wax from the solvent; (iv) repeating steps (i) to (iii) using the wax from (iii) until all pitch has been removed from the wax; (v) heating the wax to between 90 and 140° C. and oxidising molten wax with oxidizing material; and (vi) continuing the heating under and inert gas on completion of the oxidation step until intermediate peroxide products are removed.

### TECHNICAL FIELD

This invention relates to a wax composition suitable for use in comestibles. The invention also relates to a process for preparing the composition.

### BACKGROUND ART

Many comestibles include waxes added during preparation of the comestible. For example, wax is a component of chewing gum base. Waxes can also be used as protective coatings on comestibles such as cheeses and fruits. The waxes used for such purposes are typically mineral waxes such as montan wax extracted from lignites, peat waxes, ceresin wax and petroleum waxes. Among these mineral waxes, it appears that only petroleum based waxes are used in food applications: microcrystalline waxes, high melting point waxes and high sulfur microcrystalline waxes in particular. The US Food and Drug Administration (FDA) has established regulations for the use of petroleum wax (see 21 CFR 172.886 and 178.3710) and Japanese authorities consider petroleum waxes to be natural products and allows their use in products such as chewing gum. Although montan wax is not used directly in food applications, it is used in plastic processing such as plastic containers and wrappings which will come or may come into contact with food.

Use of mineral waxes in comestibles is undesirable. Mineral waxes are extracted from coal and crude petroleum oil. These raw materials contain organic chemicals which are toxic to humans. The food applicability of the waxes depends on the degree of refining or purification achieved and its usage has been regulated according to the specifications provided by authorities such as Ministry of Agriculture, Fisheries and Food, UK (The Mineral Hydrocarbons in Food Regulation, SI 1966 No. 1073. This regulation applies to England and Wales only, though similar regulations apply to Scotland and Northern Ireland). The refining achieved has been acceptable to food regulating authorities. However, recent studies have suggested toxicological effects of petroleum based waxes (“Recommendations on the use of mineral hydrocarbon in food”, Food Advisory Committee 8/93, UK) and the hydrocarbon imparted by packaging using mineral hydrocarbon waxes on food (Progress Report of the Working Party on Chemical Contaminants from Food Contact Materials: 1988 to 1992; Food Surveillance Paper No. 38, Ministry of Agriculture of Fisheries and Food). The Ministry of Agriculture, Fisheries and Food is at present reviewing studies on the toxicological impact of using petroleum based waxes as food additives and as a processing aid to update regulation of the usage of these waxes in food applications (Ministry of Agriculture of Fisheries and Food News Release 278/93 of Aug. 19, 1993).

Waxes of plant origin are known. Indeed, the palm Copernicia cerifera is a source of the common wax, carnauba. Waxes can also be extracted from sugar cane and rice. Subject to the conditions used for extraction, waxes of plant origin should provide an alternative to mineral waxes for use in comestibles.

Sugar production results in a number of by-products, one of which is mill mud. Mill mud comprises crude wax and fats, fibre, sugar, crude protein and ash (SiO₂, CaO, P₂O₅ and MgO). A crude cane wax can be extracted from mill mud. However, the crude wax is unsuitable for use in comestibles as it has a foul odour and taste and is dark green to brown in colour due to the presence of contaminants. U.S. Pat. No. 2,464,189 describes a process for the refining of sugar cane wax. However, wax produced by this process is unsuitable for use in comestibles for the following reasons:

1) The refining process is not complete. The process is only a fractionation step which removes a resinous fraction (pitch) from the sugar cane wax. The wax colour still has to be removed and stabilised. The patentees suggested further processing—for example, bleaching with acid, decolourisation, emulsification (see Example 3, line 40).

2) The reagent used in the process (acetone) is not food grade.

3) Bleaching uses reagents such as chromic and sulfuric acid which are not food grade reagents.

Since by-products of sugar production are plentiful in countries such as Australia, it would be desirable to have a process for producing a wax from such by-product (i.e., mill mud) suitable for use in comestibles.

### SUMMARY OF THE INVENTION

The object of this invention is to provide a sugar cane wax composition, and a process for preparing the composition, which wax is suitable for use in comestibles.

In one aspect, the invention provides a wax composition comprising on a weight basis: wax esters, 6.2-11%; aldehydes, 2.8-9.5%; triglycerides, 0-3.0%; alcohols, 1.8-44.5%; and, free fatty acids, sterols and polar lipids, 36.8-87.2%.

In a second aspect, the invention provides a process for preparing a wax composition from crude sugar cane wax, the process comprising the steps of:

i) heating a solution of the crude wax with a lower alcohol as solvent at the boiling point of the solvent;

ii) allowing phase separation of the solution from (i) and decanting the upper phase while hot;

iii) allowing the separated phase from (ii) to cool and separating crystallised wax from the solvent;

iv) repeating steps (i) to (iii) using the wax from (iii) until all pitch has been removed from the wax;

v) heating the wax to between 90 and 140° C. and oxidising molten wax with oxidising material; and

vi) continuing the heating under an inert gas on completion of the oxidation step until intermediate peroxide products are removed.

In other aspects, the invention provides the wax composition product of the process according to the second aspect and comestibles which include a wax composition according to the first aspect or as the product of the process according to the second aspect.

### BEST MODE AND OTHER MODES FOR CARRYING OUT THE INVENTION

The inventor has found that a wax composition suitable for inclusion in comestibles can be obtained from sugar cane. The composition is essentially odourless and colourless, desirable properties for compositions used as a comestible base or for coating comestibles.

Typical components of the wax composition according to the first aspect of the invention are set out in Table I below. The numbers in the table are the numbers of carbon atoms typically found in a member of a functional group. However, it will be appreciated that a member of a group may have a number of carbon atoms falling outside the indicated range. Members of groups are mostly straight chain saturated and unsaturated hydrocarbons.

TABLE I
Components of Groups of The Wax Composition

| Functional Groups | Typical Components |
|---|---|
| Wax Esters | C16 (fatty acid)-C24(alcohol)-C16 (fatty |
| | acid)-C36 (alcohol) |
| Aldehydes | C28-C36 |
| Tri-Glycerides | T48-T54 (total number of carbon in the acyl |
| | group) or C16-C18 (number of carbons in |
| | each acyl group) |
| Alcohols | C24-C36 |
| Free Fatty Acid | C24-C36 |
| Alkanes | C25-C35 |

The polar lipids in the wax are essentially amphipathic molecules, having a hydrophobic fatty acid part and a hydrophilic domain. The three which are commonly found are phosphoglycerides, in which fatty acids are esterified with an alcohol (glycerol) which contain a phosphate group, glycosyl diglycerides in which the fatty acids are esterified with an alcohol (glycerol) which contains a carbohydrate (sugars) and sphingolipids in which the fatty acids are esterified with an alcohol (glycerol) which contains amino groups.

As indicated above in the description of the second aspect, the method of refining the crude sugar cane wax involves heating the crude wax with an organic solvent to allow the pitch and the paler wax fraction to separate. These form two distinct phases, which can be separated by decantation. The paler wax fraction is cooled to allow the wax to crystallise and separate from the oil which remains soluble in the organic solvent. The wax is filtered until dry. The wax is melted over a hot bath and oxidised by blowing fine air bubbles through a sparger. This is continued until oxidation is complete noticeable by lack of any further increase in temperature—arising from the exothermic nature of the reaction—and colour change.

The solvent used in step (i) of the process is typically ethanol or iso-propanol which have boiling points of 78.5° C. and 82.4° C., respectively. The crude wax is typically combined with solvent at a ratio of one part (by weight) wax to nine parts solvent although ratios of 1:8 to 1:20 can also be used. Heating can be for 5 to 60 minutes although a heating time of about 30 minutes is usually adequate.

As indicated above, the upper phase formed in step (ii) contains the wax of interest. The lower phase is a resinous fraction referred to as “pitch” which contains wax of lower quality.

In step (iii), filtration or centrifugation are advantageously used to separate wax from oil-containing solvent. However, other methods known to those of skill in the art can be used.

Steps (i) to (iii) are repeated from 2 to typically no more than 5 times. The number of times the steps are repeated largely depends on the amount of pitch present in the crude wax, the rate with which the pitch settles and the rate of wax crystallisation. It appears that pitch that does not settle fast enough is occluded within the wax crystals.

The heating of the wax in step (v) of the process is advantageously carried out under an oxygen-free gas. This allows better control over the oxidation of the wax which is not initiated until the composition reaches the desired temperature. The oxygen-free gas is typically an inert gas such as nitrogen.

The oxidising material used in step (V) can be chromic acid, potassium permanganate, transition metals such as salts of noble metals such as platinum and palladium, pentavalent vanadium, cobalt (III), cerium (IV) thallium (III), mercury (II), cupric solutions, specific enzymes, and oxygen gas (see R. Stewart, “Oxidation Mechanisms, Application to Organic Chemistry”, W. A. Benjamin Inc., 1964). Preferred oxidising materials are air, oxygen, or mixtures of oxygen, nitrogen and ozone.

With regard to the final step of the process, step (vi), one of skill in the art would be able to determine when removal of the intermediate peroxide products is complete. Completion typically takes from 30 minutes to 2 hours. However, longer or shorter periods can be used depending on the degree of oxidation achieved. The inert gas used in this step is typically nitrogen.

In step (v) of the process, oxidation can be enhanced by using a catalyst. Suitable catalysts include cobalt or manganese borates and resinates (A. J. C. Andersen, Refining of Oils and Fats for Edible Purposes, Second Revised Edition, P. N. Williams, ed., Pergamon Press, 1962), ferrous salts, and Fenton's reagent which consists of ferrous salts and H₂0₂ (Roger A Sheldon and Jay K. Kochi, Metal Catalyzed Oxidations of Organic Compounds, Academic Press, 1981).

The wax compositions obtained from step (vi) of the process according to the second aspect of the invention can be further decolourised, if desired, with adsorbents or by pitch inducement. Each of these methods will now be briefly described.

Use of Adsorbents

Suitable adsorbents include activated carbons, resins, activated alumina and silica. Carbons obtained from commercial sources are satisfactory and with a wax to carbon ratio of 1:3 white wax can be produced. It is also possible to manufacture carbons that are selective towards a particular colour.

The following are typical steps in the decolourisation of the wax composition with activated carbon:

a) Wax from step (v) is heated with a lower alcohol as solvent at the boiling point of the solvent for 30 to 60 minutes with wax to activated carbon ratios of between 1:0.5 and 1:3.

b) The molten slurry is filtered hot.

c) The wax and solvent recovered is cooled until the wax crystallises and is separated by filtration.

Pitch Inducement

In the pitch inducement method, colour can be removed without the use of adsorbents. The method involves heat treatment and fractionation which results in waxes of various intensity of colour from a golden yellow to cream.

Typical steps in the reduction of the colour of the wax composition with pitch inducement follow.

(a) Wax from step (v) is heated with a lower alcohol as solvent at the boiling point of the solvent for 30 to 60 minutes.

(b) The phases of the solution from (a) are separated and the upper phase decanted while hot.

(c) The separated upper phase from (b) is allowed to cool and the crystallised wax separated from the solvent.

(d) Wax from (c) is heat treated at 80 to 110° C. in the absence of solvent for typically 15 minutes to 3 hours. (e) Steps (a) to (d) are repeated until the desired colour grade is achieved.

The crude sugar cane wax can be prepared by methods known to those of skill in the art. A suitable method is described, for example, in U.S. Pat. No. 2,508,002, the entire content of which is incorporated herein by cross-reference. A brief description of a suitable process follows.

Crude Wax Extraction

Sugar filter cake is steam heated and charged to a continuous reactor where it is mixed with solvent (naphtha) and held at the desired temperature and pressure. Wax is extracted into the solvent, which is subsequently separated from the filter cake. The separated wax-containing solvent is then passed through a flash drum and an evaporator to separate the crude wax from the solvent. The resulting filter cake is then steam stripped to recover residual solvent.

The composition of crude sugar cane wax is typically as presented in Table II.

TABLE II
Composition of Crude Sugar Cane Wax

| | Composition |
|---|---|
| Component | (% w/w) |
| Wax Ester | 5.9-8.5 |
| Alkyl Ketone | 3.2-1.6 |
| Tri-Glyceride | 0-1.6 |
| Alcohol | 7.9-8.3 |
| Free Fatty Acid/Sterol | 5.9-7.8 |
| Polar Lipid | 73.2-76.1 |

Advantages of the wax composition according to the invention and the process for preparing the composition are as follows:

1) The process produces a potential food grade vegetable wax product, which can be used as a replacement for mineral waxes in a number of food or non-food applications, including (but not limited to) chewing gum base, cheese coating, and fruit coating.

2) The process is simple and of low cost and enables economic use of wax for applications indicated in (1).

3) The wax product is colourless or has low colour (pale yellow) and little or no odour and taste.

4) The wax product has a hardness comparable to carnauba wax.

5) The wax product has good temperature stability as compared to other vegetable waxes, such as carnauba and rice wax.

Having broadly described the invention, examples of the preparation of wax composition will now be given.

### Example 1

Multiple portions of wax composition were prepared as follows: one hundred grams of crude sugar cane wax was combined with 900 grams of ethanol in a round bottom flask. The mixture was heated in a heating mantle to 78.5° C. for 30 minutes under reflux. The solution was removed from the heating mantle and the phases of pitch and the paler wax were allowed to separate. The paler wax was decanted into another round bottom flask while the wax mixture was still in solution or only partially crystallised at 65 to 75° C. The mixture was again heated to 78.50° C. for 10 minutes. The paler wax was decanted to separate it from the pitch. The heating and separation processes were repeated about four times or until no visible pitch separated from the paler wax. The pitch was reheated with about 100 grams of ethanol to recover additional paler wax. This was combined with the previously collected paler wax. The paler wax was then cooled slowly to room temperature and then in an ice bath. The cooled wax was filtered and remelted in a hot bath, in the presence of nitrogen, at a temperature between 90 and 140° C. Air or ozone was blown into the molten wax by means of a sparger until the temperature of the wax stabilised to a constant value or until there was no further visible change in the colour of the wax. The overall process was executed within several hours depending on the temperature and air distribution.

Wax composition produced by the above process had the following properties: pale yellow in colour with a sweet smell and little or no taste. The compositions of waxes are summarised in the following table.

TABLE III
Components of Wax Compositions of Example 1

| | Composition (% w/w) | |
|---|---|---|
| | Ethanol fractionated | Ethanol fractionated then |
| Component | then oxidised with air | oxidised with ozone |
| Wax Ester | 6.2-11 | 6.2-7.7 |
| Aldehyde | 8.1-9.5 | 2.5-9.5 |
| Tri-Glyceride | 0.5-3.0 | 0.5-3 |
| Alcohols | 11.5-44.5 | 1.8-44.5 |
| Free Fatty Acid + | 36.8-70 | 36.8-87.2 |
| Sterol + Polar Lipid | | |

The make-up of the composition obtained following the oxidation step depends on the extent of oxidation. If complete oxidation is achieved, the only substantial component left will be free fatty acid. However, oxidation needs to be only to the extent that sufficient colour is removed.

### Example 2

Multiple portions of wax composition were again prepared. One hundred grams of crude sugar cane wax was combined with 900 grams of isopropanol in a round bottom flask. The mixture was heated in a heating mantle to 82.4° C. The mixture was cooled slowly to room temperature and then in an ice bath. The wax was filtered and transferred into another round bottom flask. To the wax, 450 grams of ethanol was added and the mixture heated to 78.5° C. for 30 minutes. Fractionation and oxidation of this wax was carried out as in Example 1.

Wax composition produced by the above process had the following properties: pale yellow in colour with a sweet smell and little or no taste. Compositions obtained are summarised in the following table.

TABLE IV
Components of Wax Compositions of Example 2

| Component | Composition (% w/w) |
|---|---|
| Wax Ester | 10.5-11 |
| Aldehyde | 7.4-8.1 |
| Tri-Glyceride | 0-0.6 |
| Alcohols | 11.5-18.8 |
| Free Fatty Acid + Sterol + Polar Lipid | 63.4-70 |

Yields of fractions produced using processes such as described in Examples 1 and 2 are presented in Table V.

TABLE V
Fractionation Yield

Yield (%)

| Fraction | Example 1 | Example 2 |
|---|---|---|
| Oil | 24-30 | 53-55 |
| Pitch | 26-35 | 20-25 |
| Wax Composition | 34-48 | 20-25 |

It will be appreciated that many changes can be made to the processes and compositions as exemplified above without departing from the broad ambit and scope of the invention.

1. A wax composition comprising on a weight basis: wax esters, 6.2-11%; aldehydes, 2.8-9.5%; tri-glycerides, 0-3%; alcohols, 1.8-44.5%; and, free fatty acids, sterols and polar lipids, 36.8-87.2%.

2. A process for preparing a wax composition from crude sugar cane wax, the process comprising the steps of:
i) heating a solution of the crude wax with a lower alcohol as solvent at the boiling point of the solvent;
ii) allowing phase separation of the solution from (i) and decanting the upper phase while hot;
iii) allowing the separated phase from (ii) to cool and separating crystallised wax from the solvent;
iv) repeating steps (i) to (iii) using the wax from (iii) until all pitch has been removed from the wax;
v) heating the wax to between 90 and 140° C. and oxidising molten wax with oxidising material; and
vi) continuing the heating under an inert gas on completion of the oxidation step until intermediate peroxide products are removed.

3. The process. according to claim 2, wherein said lower alcohol is ethanol or iso-propanol.

4. The process according to claim 2, wherein said crude wax is combined with solvent at a ratio of 1:8 to 1:20 by weight.

5. The process according to claim 4, wherein said ratio is 1:9.

6. The process according to claim 2 wherein in step (i) said solution is heated for 5 to 60 minutes.

7. The process according to claim 6, wherein said solution is heated for about 30 minutes.

8. The process according to claim 2, wherein in step (iii) said separation is by filtration or centrifugation.

9. The process according to claim 2, wherein steps (i) to (iii) are repeated from 2 to 5 times.

10. The process according to claim 2, wherein in step (v) said heating is carried out under an oxygen-free gas.

11. The process according to claim 10, wherein said gas is nitrogen.

12. The process according to claim 2, wherein said oxidising material of step (v) is selected from the group consisting of air, oxygen, and mixtures of oxygen, nitrogen and ozone.

13. The process according to claim 2, wherein in step (v) said oxidation is carried out in the presence of a catalyst.

14. The process according to claim 10, wherein said catalyst is selected from the group consisting of a borate or resinate of cobalt or manganese, ferrous salts, and Fenton's reagent.

15. The process according to claim 2 comprising the further steps of:
vii) heating wax from step (vi) with a lower alcohol as solvent at the boiling point of the solvent with activated carbon present at a wax to carbon ratio of 1:0.5 to 1:3;
viii) filtering the molten slurry while hot;
ix) allowing the recovered wax/solvent mixture to cool and separating crystallised wax therefrom.

16. The process according to claim 2 comprising the further steps of:
(vii) heating wax composition from step (vi) with a lower alcohol as solvent at the boiling point of said solvent for 30 to 60 minutes;
(viii) allowing phase separation of the solution from (vi) and decanting the upper phase while hot;
(ix) allowing the separated upper phase from (viii) to cool and separating crystallised wax from said solvent;
(x) heating wax from (ix) in the absence of solvent for 15 minutes to 3 hours; and
(xi) repeating steps (vii) to (x) until the desired degree of decolourisation is achieved.

17. A comestible which includes the wax composition of claim 1.
